(19) United States
(12) Patent Application Publication
(10) Pub. No.: US 2016/0169464 A1
(43) Pub. Date: Jun. 16, 2016

(54) LIGHTING FIXTURE

(71) Applicant: YAMASE ELECTRIC CO., LTD., Miyagi (JP)

(72) Inventor: Hirofumi Hirano, Kami-gun, Miyagi (JP)

(21) Appl. No.: 14/907,381

(22) PCT Filed: Jul. 24, 2014
(86) PCT No.: PCT/JP2014/069629

§ 371 Date: Jan. 25, 2016

(30) Foreign Application Priority Data
Jul. 26, 2013 (JP) 2013-156113

(51) Int. Cl. F21S 8/04; G09F 13/02; G09F 13/22

(52) U.S. Cl. CPC F21S 8/04; G09F 13/22; G09F 13/02; F21Y 2101/02; G09F 2013/222

(57) ABSTRACT

A lighting fixture includes a light source for lighting; a lighting fitting base that holds the light source and includes a wiring member for supplying electric power to the light source; a display-object holding member provided on the lighting fitting base at a predetermined position; and a thin plate-shaped display object held by the display-object holding member. The display object is detachably attached with the display-object holding member. A portion of a light beam emitted from the light source is, for example, reflected, scattered, or diffracted so as to be used as a light source for illuminating the display object, and a space for receiving a large display object is provided in or on the exterior of the main body of the lighting fixture body.

### TECHNICAL FIELD

The present invention relates to a lighting fixture called a base light attached to, for example, a ceiling or a beam to light the surrounding environment in, for example, a room, a public space, a station building, or a station platform.

### BACKGROUND ART

A lighting fixture in which a portion of a light source of the lighting fixture is removed to provide a space for a display object so that the lighting fixture serves as an advertising medium has been proposed. PTL 1, for example, proposes a lighting fixture that allows a display object, such as an advertisement, to be placed near the lighting fixture so that the combination of an advertising medium and the lighting fixture serves as a new advertising medium.

PTL 2, for example, describes a lighting fixture including a light emitting unit having an advertising adhesive film attached thereto or an advertisement printed thereon, so that the lighting fixture functions as an advertising medium.

PTL 3, for example, describes an LED lighting fixture in which a light source and a lighting fitting are combined. Side surfaces of the fixture are illuminated by using a portion of an illumination light beam, and an advertisement or the like is displayed on each side surface.

### CITATION LIST

### Patent Literature

PTL 1: Japanese Unexamined Patent Application Publication No. 2005-181506

PTL 2: Japanese Unexamined Patent Application Publication No. 2002-260439

PTL 3: Japanese Unexamined Patent Application Publication No. 2012-069367

### SUMMARY OF INVENTION

### Technical Problem

In the lighting fixture according to PTL 1, since one of fluorescent lamps is removed to enable an advertising object to be displayed, the desired brightness cannot be obtained and the intended function of the lighting apparatus is greatly impaired. In addition, to display an advertising object near the lighting fixture, an attachment member is required and an attaching process needs to be performed. This leads not only to an increase in costs but also to a risk that the advertising object will block the light beam from the light source and the lighting function will be impaired. Thus, the lighting fixture does not have sufficient practical applicability.

The lighting fixture according to PTL 2 includes a fluorescent lamp, and therefore an advertising adhesive film is attached or an advertisement is printed in a region excluding regions near bases at the ends where the temperature increases. Unfortunately, the fluorescent lamp has a small diameter, and the advertisement displayed thereon is not clearly visible. In addition, the printing base material and the print need to be formed of a transparent material to provide the required lighting function, and therefore the advertisement does not have sufficient appeal. Moreover, since the advertising object cannot be replaced, the lighting fixture is not suitable for displaying a short-term advertising object in, for example, a station.

In the lighting fixture according to PTL 3, components at both sides are shaped such that a portion of a light beam from an LED is reflected so as to illuminate outer side surfaces of the components at both sides, thereby displaying advertising objects on the outer side surfaces. However, the area of the side surfaces of the fixture is small, and the advertisement or image displayed thereon is not clearly visible. Thus, there is room for improvement in terms of serviceability of the lighting fixture as the advertising medium.

The lighting fixture of the present invention has been provided to solve the above-described problems. The lighting fixture includes a mechanism for displaying or holding an advertising object, the mechanism being devised to enable the advertising object to be easily replaced, so that the lighting fixture serves as an advertising medium having various applications. The advertising object is illuminated by using a light source for lighting, so that a highly visible advertising object can be displayed. Thus, a new lighting fixture having both a lighting function and an advertising function is provided.

### Solution to Problem

To achieve the above-described object, the lighting fixture of the present invention is configured to be capable of displaying or holding a so-called advertising object such as a slogan, a sign, a promotional advertisement, or a notification advertisement (hereinafter referred to simply as an advertising object) on a lighting fitting base such that the advertising object is detachably attachable. The advertising object, which is substantially rectangular film-shaped, is supported by two supports at the ends thereof and is attached to the lighting fitting base at a predetermined position. A predetermined tension is applied to the advertising object so that the flatness of an advertisement display surface can be maintained. The surface on which the advertising object is displayed can be illuminated with a light beam from the light source, so that the visibility of the advertising object is increased.

The lighting fixture of the present invention is configured such that the advertising object can not only be easily held, attached, and detached but can also be displayed outside the main body of the lighting fitting base so that a larger advertising object can be displayed. More specifically, a film-shaped advertising object is installed such that the advertising object is stretched between rod-shaped supports provided at both ends of the advertising object. The size of the advertising object can be selected in accordance with the surrounding space, so that a highly visible advertising object can be displayed irrespective of the size of the main body of the lighting fixture. Although the film-shaped advertising object is typically made of a resin base material, since a predetermined tension is applied to the advertising object by a spring or the like, expansion and contraction due to a temperature change and differences in sizes caused in the manufacturing process can be absorbed. Therefore, the advertising object does not become slack and the flatness thereof can be maintained.

The lighting fixture of the present invention includes a main body having a space for displaying a display object and a holding member with which the display object can be easily attached so that the displayed advertisement can be easily replaced at short intervals.

More specifically, the present invention is as follows:

The present invention (1) is a lighting fixture including a light source for lighting; a lighting fitting base that holds the light source and includes a wiring member for supplying electric power to the light source; a display-object holding member provided on the lighting fitting base at a predetermined position; and a thin plate-shaped display object held by the display-object holding member, wherein the display object is detachably attached with the display-object holding member.

The present invention (2) is the lighting fixture according to (1), wherein the thin plate-shaped display object is mounted on the lighting fitting base while being held by rod-shaped support members at both ends, and wherein the rod-shaped support members are provided with a mechanism for applying a predetermined tension to the thin plate-shaped display object.

The present invention (3) is the lighting fixture according to (1) or (2), wherein the thin plate-shaped display object is mounted on the lighting fitting base while being held by rod-shaped support members at both ends, and wherein the lighting fitting base includes a lock mechanism that prevents the rod-shaped support members from being detached unless a predetermined operation is performed after the rod-shaped support members are attached to the lighting fitting base.

The present invention (4) is a lighting fixture, wherein a lighting fitting base includes a receiving member having a predetermined curved surface and an elastic body that is in contact with the receiving member, and wherein the receiving member and the elastic body form a display-object holding mechanism that holds a display object.

The present invention (5) is the lighting fixture according to any one of (1) to (4), wherein the lighting fitting base includes a reflecting-scattering member that reflects or scatters a light beam emitted from the light source, so that the light beam illuminates the display object.

The present invention (6) is the lighting fixture according to (1) including a pair of display-object holding members arranged on the lighting fitting base at predetermined positions so as to oppose each other; and a thin plate-shaped display object that is detachably held by the display-object holding members while a predetermined tension is applied to the thin plate-shaped display object, wherein the display-object holding members are retained at predetermined positions and configured to be capable of eliminating the applied tension.

The present invention (7) is the lighting fixture according to (6), wherein the thin plate-shaped display object includes projections at predetermined positions at both ends and is held by being engaged with portions of the display-object holding members.

The present invention (8) is the lighting fixture according to any one of (1) to (7), wherein the light source for lighting includes a bottom-surface illuminating portion and a side-surface illuminating portion that are dispersed in two directions, the bottom-surface illuminating portion serving as a main light source and the side-surface illuminating portion illuminating the thin plate-shaped display object.

The present invention (9) is a lighting fixture including a light source for lighting; a lighting fitting base that holds the light source and includes a wiring member for supplying electric power to the light source; and a display-object holding mechanism for holding a display object, the display-object holding mechanism having a structure such that an inclined surface having a predetermined length in a longitudinal direction and a vertical wall surface that opposes and corresponds to the inclined surface are provided on the lighting fitting base, a cylindrical member having a predetermined diameter is disposed between the inclined surface and the wall surface, and the cylindrical member moves along the inclined surface and comes into contact with the wall surface due to gravity.

### Advantageous Effects of Invention

The lighting fixture according to the present invention not only provides the main function of lighting the surrounding environment as a light source, but also serves as an advertising medium with increased serviceability owing to the structure for displaying an advertising object in a replaceable manner and making the advertising object bright and conspicuous. Thus, a new type of lighting fixture is proposed.

With the lighting fixture of the present invention, a larger advertising object may be used irrespective of the size of the main body by arranging the advertising object so as to protrude from the main body of the lighting fixture. Thus, the versatility of the lighting fixture as an advertising medium can be increased.

With the lighting fixture of the present invention, the additional function can provide an advertising income. This provides an incentive to employ, as a replacement for an old lighting fixture or as a new lighting fixture, a lighting fixture that has a power saving property but requires high initial investment, such as an LED lighting fixture or an organic EL lighting fixture, which is expected to come into widespread use.

The lighting fixture of the present invention is capable of displaying characters and marks in a clearly visible manner, and therefore can be used as a display board for a slogan or a motto.

With the lighting fixture of the present invention, conventional display objects such as signs that hang from the ceiling will no longer be necessary. Therefore, components for installing the signs or the like and installation processes can be omitted, and the costs can be reduced accordingly.

### BRIEF DESCRIPTION OF DRAWINGS

FIG. 1 is an overall perspective view of a lighting fixture according to a first embodiment of the present invention viewed from below.

FIG. 2 is an overall perspective view of the lighting fixture illustrated in FIG. 1 viewed from the back (above).

FIG. 3 is a longitudinal sectional view of the lighting fixture illustrated in FIG. 1.

FIG. 4 illustrates the structure of an advertising-object support member of the lighting fixture illustrated in FIG. 1.

FIG. 5 shows partial enlarged views illustrating the structure of the advertising-object support member of the lighting fixture illustrated in FIG. 1.

FIG. 6 illustrates the operation of the advertising-object support member of the lighting fixture illustrated in FIG. 1.

FIG. 7 is a partial perspective view of an advertising-object support member according to a second embodiment of the present invention.

FIG. 8 is an overall perspective view of a lighting fixture according to a third embodiment of the present invention viewed from below.

FIG. 9 is a longitudinal sectional view of the lighting fixture illustrated in FIG. 8.

FIG. 10 illustrates the structure of an advertising object for a lighting fixture according to a fourth embodiment of the present invention.

FIG. 11 is a longitudinal sectional view of the lighting fixture illustrated in FIG. 10.

FIG. 12 is an overall perspective view of a lighting fixture according to a fifth embodiment of the present invention viewed from below.

FIG. 13 is an overall perspective view of the lighting fixture illustrated in FIG. 12 viewed from the back (above).

FIG. 14 illustrates the structure of a support member of the lighting fixture illustrated in FIG. 12 viewed from the back (above).

FIG. 15 illustrates the structure of the support member of the lighting fixture illustrated in FIG. 12 viewed from below.

FIG. 16 is a partial enlarged view illustrating the structure of an advertising-object support member of the lighting fixture illustrated in FIG. 12.

FIG. 17 is a partial enlarged view of an advertising object for the lighting fixture illustrated in

FIG. 18 is an enlarged side view of an advertising-object supporting portion of the lighting fixture illustrated in FIG. 12.

FIG. 19 is a side view illustrating a tension-applying operation of the lighting fixture illustrated in FIG. 12.

FIG. 20 is a side view illustrating a tension-eliminating operation of the lighting fixture illustrated in FIG. 12.

FIG. 21 is a side view illustrating the operation of an advertising film when a tension is applied by the lighting fixture illustrated in FIG. 12.

FIG. 22 is a side view illustrating the operation of the advertising film when no tension is applied by the lighting fixture illustrated in FIG. 12.

FIG. 23 is an overall perspective view of a lighting fixture according to a sixth embodiment of the present invention viewed from below.

FIG. 24 is a longitudinal sectional view of the lighting fixture illustrated in FIG. 23.

FIG. 25 is a partial perspective view of the lighting fixture illustrated in FIG. 23 viewed from below.

FIG. 26 is a sectional view illustrating a first advertising-object-displaying operation of the lighting fixture illustrated in FIG. 23.

FIG. 27 is a sectional view illustrating a second advertising-object-displaying operation of the lighting fixture illustrated in FIG. 23.

FIG. 28 is a sectional view illustrating a third advertising-object-displaying operation of the lighting fixture illustrated in FIG. 23.

FIG. 29 is a partial perspective view of the lighting fixture illustrated in FIG. 23 viewed from below when no advertisement is displayed.

FIG. 30 is an overall perspective view of a lighting fixture according to a seventh embodiment of the present invention viewed from below.

FIG. 31 is a perspective view illustrating the structure of a tension-applying mechanism of the lighting fixture illustrated in FIG. 30.

FIG. 32 is an overall perspective view of a lighting fixture according to an eighth embodiment of the present invention viewed from below.

FIG. 33 is an overall perspective view illustrating the state in which display objects on the lighting fixture illustrated in FIG. 32 are reversed.

FIG. 34 is a development view of each display object on the lighting fixture illustrated in FIG. 32.

FIG. 35 is a sectional view of a driving mechanism of the lighting fixture illustrated in FIG. 32.

FIG. 36 is a partial perspective view illustrating a display-object reversing function of the lighting fixture illustrated in FIG. 32.

FIG. 37 is a longitudinal sectional view of a lighting fixture according to a ninth embodiment of the present invention.

### DESCRIPTION OF EMBODIMENTS

Lighting fixtures according to embodiments of the present invention will be described with reference to the drawings. In the following embodiments, LED chips 5 are an example of a light source according to the present invention. Frames 1, a chassis 2, lamp covers 6, and end caps 7 form an example of a display-object holding member according to the present embodiment. Advertising films 12 and advertising objects 25 are an example of a display object according to the present invention. Support shafts 13 are an example of a rod-shaped support member according to the present invention. An urging spring 17 is an example of a mechanism for applying a predetermined tension according to the present invention. An end portion 14a of a lock lever 14 and an opening 7a form an example of a lock mechanism according to the present invention. Advertisement receivers 23 are an example of a receiving member according to the present invention. Retainer bands 26 are an example of an elastic body according to the present invention. The advertisement receivers 23, a bottom holder 24, the retainer bands 26, lower hinges 27, and upper hinges 28 form an example of a display-object holding mechanism according to the present invention. Knurl portions 6a are an example of a reflecting-scattering member according to the present invention.

### First Embodiment

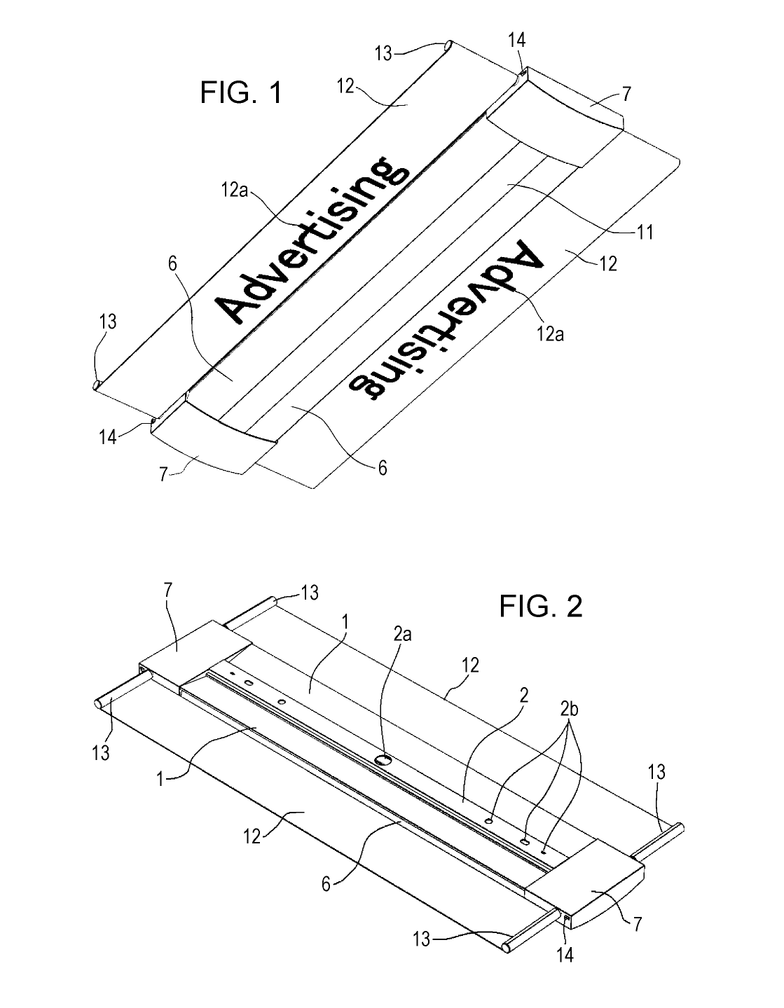

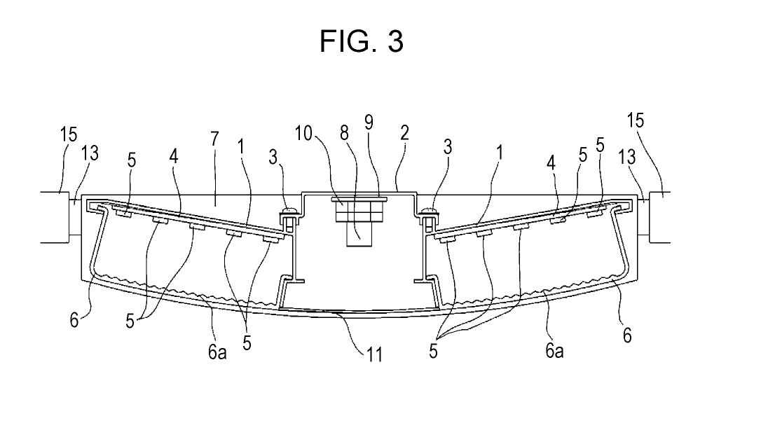

FIGS. 1 to 3 are overall perspective views of a lighting fixture according to an embodiment of the present invention viewed from below and above and a partial perspective view illustrating the inner structure of the lighting fixture.

Referring to FIG. 1, reference numeral 1 denotes a pair of left and right frames that form the base of a lighting fitting and that are formed of a light metal, such as an aluminum alloy, by extrusion molding. Since the frames 1 are formed by extrusion molding, the frames 1 have the same cross-sectional shape and a predetermined length in the longitudinal direction. Reference numeral 2 denotes a chassis formed of a light metal, such as an aluminum alloy, by extrusion molding, similar to the frames 1. The chassis 2 has a cross-sectional shape such that the chassis 2 can be fitted to the frames 1, and is fastened with screws 3 at predetermined positions. The chassis 2 has a hole 2a that allows a wire arranged behind the ceiling to extend therethrough. The wire is connected to a power supply (not shown) arranged in the lighting fitting, so that electric power can be supplied to LED substrates described below. A pair of attachment holes 2b used to mount the lighting fixture to a ceiling structure are arranged symmetrically in the left-right direction.

Reference numeral 4 denotes the LED substrates attached to the frames 1 at predetermined positions. The LED substrates 4 may be attached by means of screws or adhesion, and are preferably secured with screws with a highly thermally conductive adhesive or a highly thermally conductive grease, such as silicone grease, applied thereto. In this case, an increase in the temperature of LED chips 5 can be suppressed and the service life period can be increased.

Circuit patterns (not shown) are formed on the LED substrates 4. The LED chips 5, which are mounted on the LED substrates 4 by a surface mounter or the like, are capable of emitting light by receiving electricity from the power supply (not shown). A predetermined number of LED chips 5 are mounted at predetermined positions. The number of LED chips 5 and the brightness thereof are selected as appropriate to ensure the desired intensity of illumination in the illuminated space.

Reference numeral 6 denotes lamp covers formed of a material having a high light transmittance, such as polycarbonate. White dispersant is mixed into the material as appropriate to obtain milky-white lamp covers 6, or the lamp covers 6 are coated with a material to which the dispersant is added, so that light beams from the LED chips 5 are appropriately scattered and glare does not occur. Ridge-shaped knurl portions 6a are formed on the inner surfaces of the lamp covers 6 so as to extend in a longitudinal direction. Accordingly, the light beams from the LED chips 5 are reflected in the lateral direction, so that the illuminating angle is increased and the light is reflected and diffracted toward the side surfaces. Thus, advertising surfaces of advertising objects described below are illuminated and the visibility thereof is effectively increased. Since the lamp covers 6 have the same cross-sectional shape, they can be formed of a resin by extrusion molding, and therefore can be manufactured at a low cost. The lamp covers 6 are attached to the frames 1 at predetermined locations by utilizing the elasticity thereof so as to leave no backlash or gap.

Reference numeral 7 denotes a pair of left and right end caps that are fixed to the frames 1 with screws (not shown). Reference numeral 8 denotes an attachment bolt installed on the ceiling, 9 denotes an attachment washer, and 10 denotes a nut. The lighting fixture is fixed by screwing the nut 10 onto the chassis 2. The lighting fixture has an integral structure. The wiring in the lighting fixture is completed beforehand, so that the installation of the lighting fixture is completed simply by finishing the wiring on the ceiling after attaching the lighting fixture to the ceiling. The chassis 1 has a large opening that opens downward, so that a tool such as a spanner or a wrench can be used. Reference numeral 11 denotes a center cover. The center cover 11 is mounted after the lighting fixture is installed, and serves as a cover cap that blocks the nut and wires from view. The center cover 11 is sufficiently long in the longitudinal direction, and has a snap-fitting structure (not shown) so that the center cover 11 can be easily attached and detached.

Reference numeral 12 denotes advertising films called advertising banners having a rectangular shape. The advertising films 12 are made of a resin base material, such as PET or PVC, to which various additives are added, or are subjected to surface treatment so that weather resistance and printability are imparted thereto. The advertising films 12 have images 12a including characters and patterns for advertisement, slogans, instructions, etc., printed thereon. The advertising films 12 may be surface-coated to protect the printed images. The advertising films 12 are preferably formed of a very thin material having a thickness of about 0.1 mm. It is important that the weight thereof is small in the present invention. This is because when the advertising objects are large bonding materials having an adhesive film or the like, the receiving surfaces of the lighting fitting need to be formed of a strong metal. This leads to an increase in the weight and load on the ceiling, resulting in a reduction in safety in the event of an accident. Moreover, the manufacturing cost is increased and the selling price is increased accordingly. Reference numeral 13 denotes support shafts that support the advertising films 12 at both ends thereof. The support shafts 13 are capable of supporting the advertising films 12 without slack when the support shafts 13 are attached to the end caps 7. The support shafts 13 have built-in mechanisms described below that apply a tension to the films so that the films do not become slack even when the films expand or contract in accordance with a change in the environment.

Reference numeral 14 denotes lock levers, which are mechanisms for retaining the support shafts 13 attached to the end caps 7 so that the support shafts 13 are not easily detached. The lock levers 14 may be unlocked when the advertising films 12 are to be replaced.

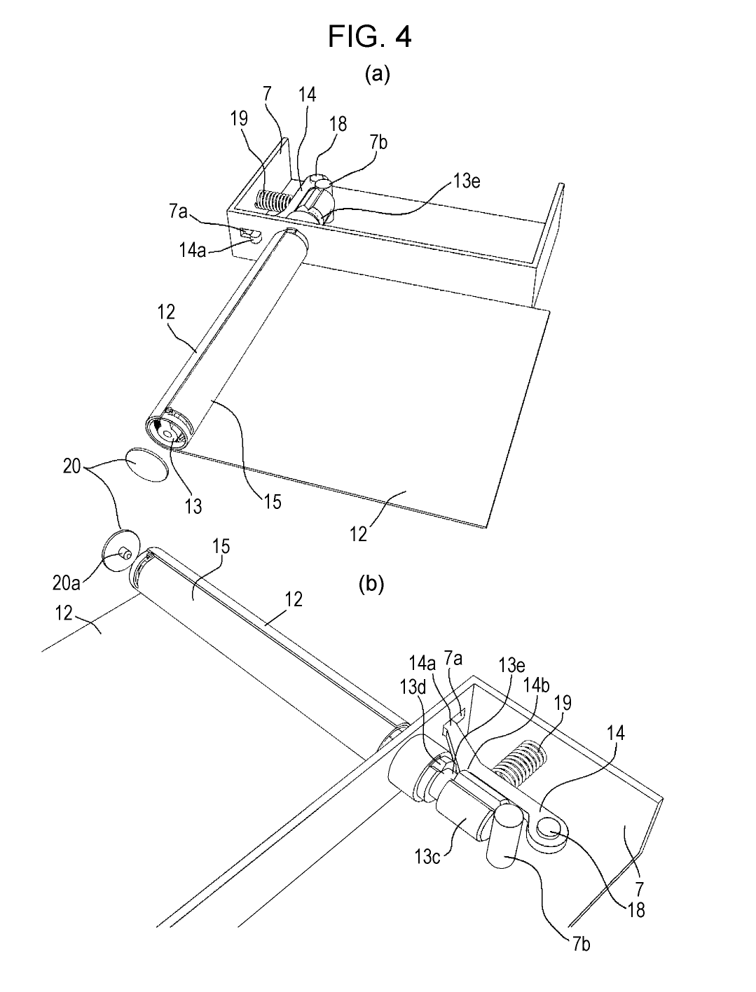

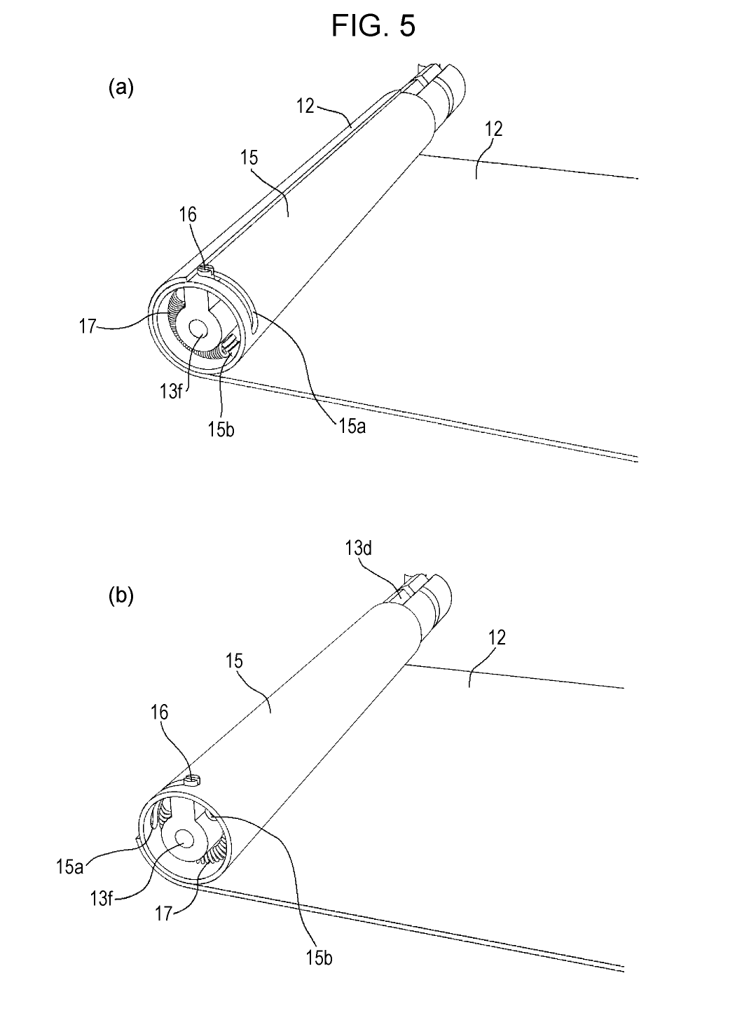

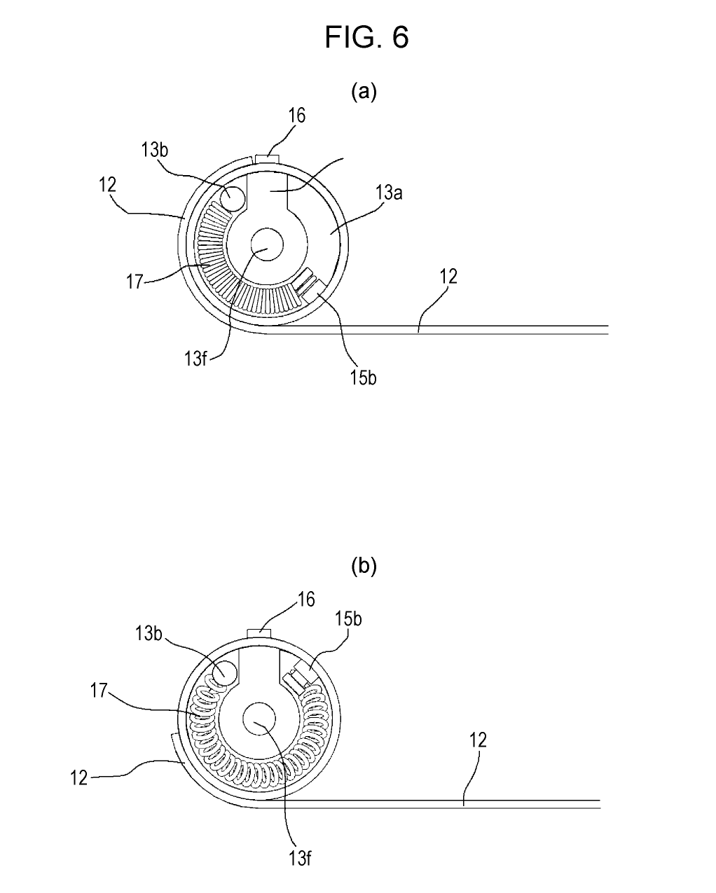

The structure of a section around each support shaft will be described with reference to FIGS. 4 to 6. FIG. 4 shows perspective views illustrating the overall mechanism of a section around the support shaft 13 viewed in two directions. FIG. 5 shows detailed perspective views of the support shaft 13. FIG. 6 illustrates the urging function of the support shaft 13. The support shaft 13 has a space 13a for receiving an urging spring described below only at an end thereof. A spring hook shaft 13b is disposed in the space. An insertion portion 13c that is inserted into a corresponding one of the above-described end caps 7, a V-groove 13d for stopping the rotation, and a groove 13e which retains the lock mechanism when the support shaft 13 is attached or detached are provided at the other end of the support shaft 13.

The V groove 13d engages with a V-shaped projection (not shown), which is provided in an insertion hole of the end cap 7, to regulate the rotational direction so that accompanying rotation does not occur even when a rotating collar described below rotates. A hole 13f, which receives a cap described below, is also provided.

Reference numeral 15 denotes a rotating collar that is rotatably attached to the support shaft 13. The rotating collar has, at an end thereof, an oblong cut 15a that extends a distance corresponding to an angle of approximately 90 degrees, and a retaining portion 15b for an urging spring described below.

The above-described advertising film 12 is bonded to the rotating collar 15 at a predetermined strength so as to be parallel to the shaft.

Reference numeral 16 denotes a retaining screw that extends through the cut 15a in the rotating collar 15 and is attached to the support shaft 13 so that the rotatable angle of the rotating collar 15 is about 90 degrees.

Reference numeral 17 denotes an urging spring that is attached to an end portion of the spring hook shaft 13b of the support shaft 13 at one end and to a retaining portion (cut) 15a of the rotating collar at the other end.

Reference numeral 18 denotes a lock lever shaft that is fixed to the end cap 7 at a predetermined position. In FIG. 4, an upper portion of the end cap 7 is omitted to make the inner structure visible for convenience. A lock lever 14 is rotatably attached to the lock lever shaft 18, and an end portion 14a thereof extends through the opening 7a in the end cap 7 so as to project outward. The lock lever 14 has a retaining portion 14b that is retained by the groove 13e in the support shaft 13. The support shaft 13 can be inserted simply by pushing it inward. However, to remove the support shaft 13, it is necessary to hold the end portion 14a of the lock lever 14 and rotate the lock lever 14 to release the retaining portion 14a from the retained state. The reason for this is to prevent the support shaft 13 from becoming detached unexpectedly so that even when the advertising film 12 receives an external force, such as that of a strong wind, the support shaft 13 will not become detached unexpectedly and fall. Reference numeral 19 denotes a lock-lever pressing spring that is attached to the end cap 7 and applies a predetermined pressure to the lock lever 14 in such a direction that the lock lever 14 is retained. Reference numeral 7b denotes a support shaft stopper that regulates the position of the support shaft 13 in the axial direction.

Reference numeral 20 denotes a shaft cap made of a resin and having a boss portion 20a. The shaft cap 20 is press-fitted to the hole 13f in the support shaft 13 and covers the mechanism including the urging spring 17 and other components.

The operation will be described by additionally referring to FIG. 6.

The advertising film 12, which is typically made of a resin base material, has a coefficient of linear expansion as high as several times that of a metal, and the dimensions thereof vary by several millimeters per meter in accordance with a change in the environment. For example, vinyl chloride has a coefficient of linear expansion as high as 7×10⁻⁵ (1/K), and dimensions thereof vary by 2.1 mm per 1 m, that is, 4.2 mm for 2 m, in response to a temperature change of 30 degrees. The amount of variation is half the above-mentioned amount for aluminum, and one-quarter for iron. This means that a film stretched between supports fixed to a metal or the like expands and becomes slack when the temperature increases. When the temperature decreases, the film contracts and a tension is applied at the fixed shaft portions, resulting in a risk of breakage or the like of the film. When an advertising object, such as the advertising film 12, becomes slack and the flatness thereof cannot be maintained, there is a risk that the advertisement quality will be greatly reduced and the value of the advertisement will be impaired. According to the present invention, a rotating mechanism that is initially urged by a predetermined force is provided, so that the expansion and contraction of the advertising film 12 can be absorbed within a range corresponding to an angle of about 90 degrees between the position illustrated in FIG. 6(a) and the position illustrated in FIG. 6(b). When, for example, the rotating collar 15 has an outer diameter of 20 mm, the adjustable length corresponding to the angle of 90 degrees is about 15 mm, which is ±7.5 mm when the standard dimension is set at the center. Accordingly, not only the above-described expansion and contraction due to a temperature change but also dimensional differences between the advertising films 12 in the longitudinal direction can be absorbed.

### Second Embodiment

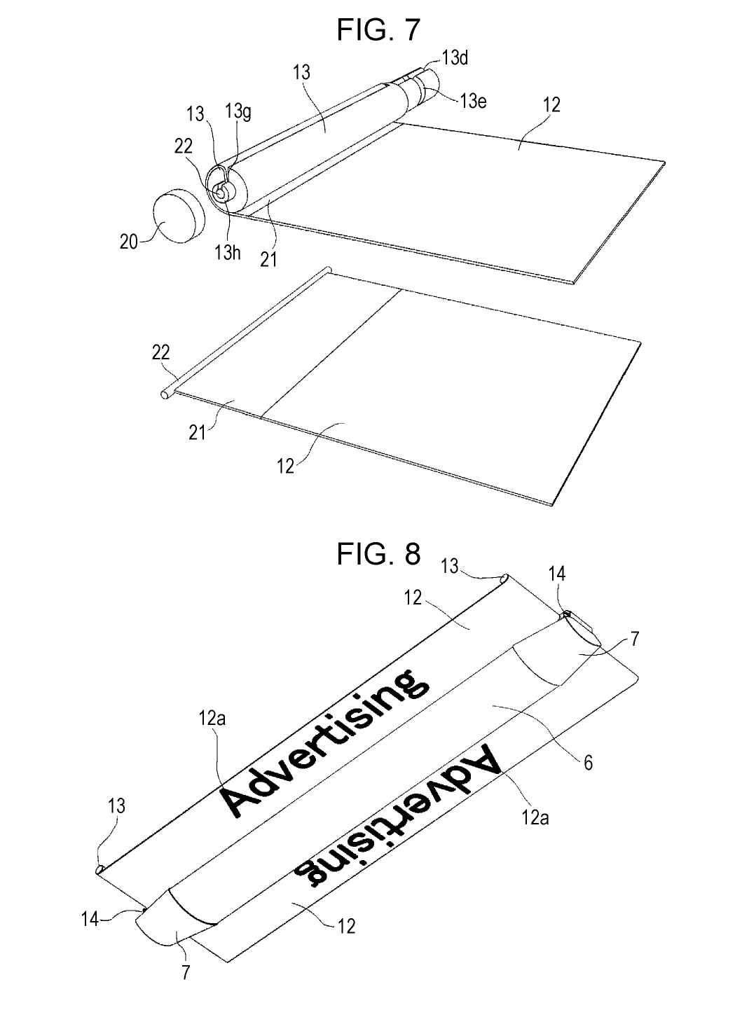

A second embodiment will be described with reference to FIG. 7. A hole 13f for receiving a film retaining bar 22 described below is formed in the above-described support shaft 13 in a central region thereof so as to extend over a distance greater than the length of the film retaining bar 22. (In FIG. 7(a), the hole 13f is not visible since the film retaining bar 22 is inserted therethrough. The position of the hole 13f is illustrated in FIGS. 5 and 6.) A slit 13g is formed so as extend over a distance corresponding to the length of the hole 13f. A boss portion 13h is formed such that a shaft cap described below can be attached thereto.

FIG. 7(b) illustrates the state before the advertising film 12 is attached. Reference numeral 21 denotes a stretching sheet made of an elastic material, such as rubber. The film retaining bar 22 is attached to an end of the stretching sheet. The advertising film 12 is attached to the other end. As illustrated in FIG. 7(a), the stretching sheet 21 is wrapped about half way around the support shaft 13, and the retaining bar 22 is attached to the support shaft 13 by being inserted into 13f in the central region. When the advertising film 12 expands or contracts in accordance with a change in the environment as described above, the stretching sheet 21 expands or contracts so as to absorb the expansion or contraction of the advertising film 12 so that the advertising film 12 does not become slack or receive an excessive tension. The stretching sheet 21 made of rubber or the like has a large surface friction and does not easily slide along the surface of the support shaft 13. Therefore, the stretching sheet 21 is preferably subjected to surface treatment such as fluorine coating to reduce the surface friction coefficient thereof. It is also effective to form the stretching sheet 21 in a concertina structure to increase the range of expansion and contraction.

### Third Embodiment

FIG. 8 is an overall perspective view of a lighting fixture according to a third embodiment of the present invention viewed from below.

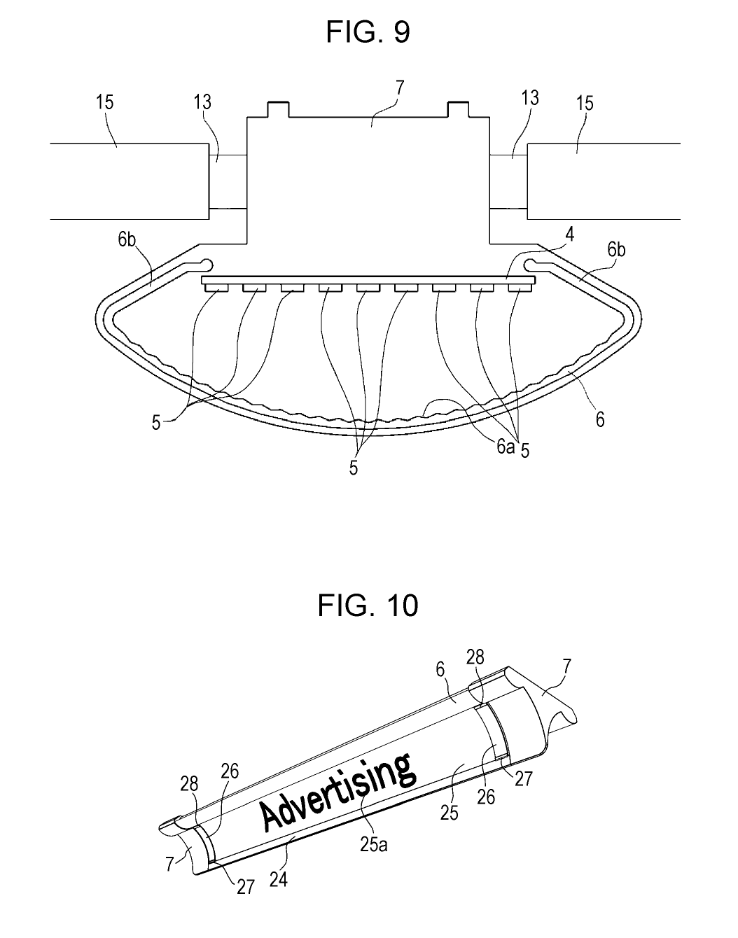

FIG. 9 is a longitudinal sectional view of the lighting fixture.

Components having the same functions as those in the first embodiment are denoted by the same reference numerals.

The lighting fixture is a so-called thin single-fluorescent-lamp-type lighting fixture that has a small width. Reference numeral 4 denotes an LED substrate, and 5 denotes LED chips. Reference numeral 6 denotes a lamp cover that is substantially rhombus shaped in cross section and includes ridge-shaped knurl portions 6a extending continuously in a longitudinal direction on the inner surface thereof in a lower region. Reference numeral 7 denotes a pair of left and right end caps. Components such as a chassis, frame, etc., are not illustrated. Reference numeral 12 denotes advertising films and 13 denotes support shafts. The advertising films 12 and the support shafts 13 are attached to the end caps 7. Reference numeral 12a denotes printed advertising objects (images). Reference numeral 14 denotes lock levers that are partially exposed at the end caps 7 and serve as mechanisms for preventing the support shafts 13 from being detached. The lamp cover 6 has end portions 6b at the top side thereof. Light beams from the LED chips 5 are reflected and scattered by the knurl portions 6a on the inner surface of the lamp cover 6, so that light reaches an upper region. It has been found that, when the spaces above and below the LED substrate 4 are defined as upper and lower hemispheres, more than 5% of the light reaches the upper hemisphere. Common LED chips 5 emit a main light beam in a range of 60 degrees in the left-right direction, and no light is diffracted toward the upper hemisphere. Therefore, it can be said that the shape of the lamp cover 6 and the knurl portions 6a on the inner surface have a large effect. Since the advertising films 12 are located near the lighting fitting, the light component of 5% provides a sufficient illuminating effect, and the combination of the above-described thin lighting fixture and LED chips provides a sufficient advertising effect. When a fluorescent lamp is arranged instead of the LED chips, the effect of illuminating the back side will be more than sufficient.

### Fourth Embodiment

FIG. 10 is an overall perspective view of a lighting fixture according to a fourth embodiment of the present invention viewed from below.

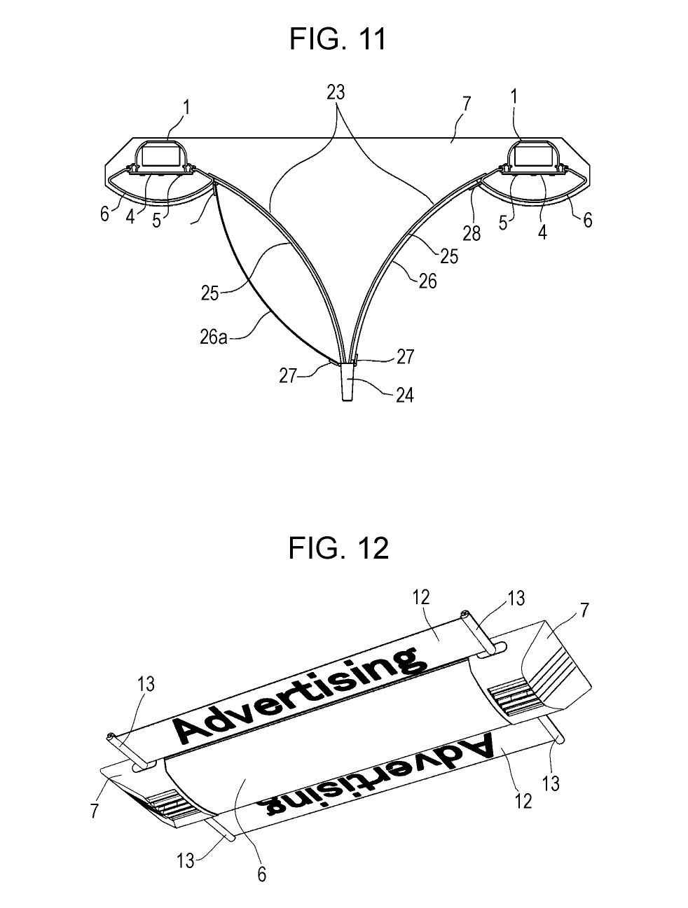

FIG. 11 is a longitudinal sectional view of the lighting fixture.

Components having the same functions as those in the first embodiment are denoted by the same reference numerals.

Reference numeral 1 denotes frames, 4 denotes LED substrates, and 5 denotes LED chips. Reference numeral 6 denotes lamp covers, and 7 denotes end caps. A chassis, power supply, etc., are not illustrated. Reference numeral 23 denotes advertisement receivers made of a rigid material having a concave surface. The advertisement receivers 23 may be formed integrally with the frames 1. The advertisement receivers 23 are formed so as to extend downward, thereby providing large spaces for advertisement and enabling the advertisement to be displayed at locations where the illumination light beam easily reaches. Since advertising objects 25 are vertically oriented, the visibility from a distance is increased. In addition, since the advertising objects 25 are arranged so as not to block the main light beam from the light source, the lighting fixture has sufficient brightness. Reference numeral 24 denotes a bottom holder that fastens end portions of the advertisement receivers 23 and holds lower hinges 27 described below. Reference numeral 25 denotes the advertising objects that may be formed of, for example, a film or cardboard, each advertising object 25 having an advertising image 25a printed on one side thereof. The advertising objects 25 are arranged so as to extend along the advertisement receivers 23, and are retained by being pressed by retainer bands 26 described below. Reference numeral 26 denotes the retainer bands made of a transparent resin or the like and having elasticity. The retainer bands 26 are held by the lower hinges 27 and upper hinges 28 at the left and right sides. The retainer bands 26 may instead be provided at a central position. The retainer bands 26 exert an elastic force that enables themselves to be in tight contact with the advertisement receivers 23 at a predetermined pressure. Each retainer band 26 can be held and pulled at a central portion thereof so that the retainer band 26 is retained in a reversely curved state, as denoted by 26a in the cross-sectional view of FIG. 11. In this state, the advertising objects 25 can be replaced.

### Fifth Embodiment

FIG. 12 is an overall perspective view of a lighting fixture according to a fifth embodiment of the present invention viewed from below.

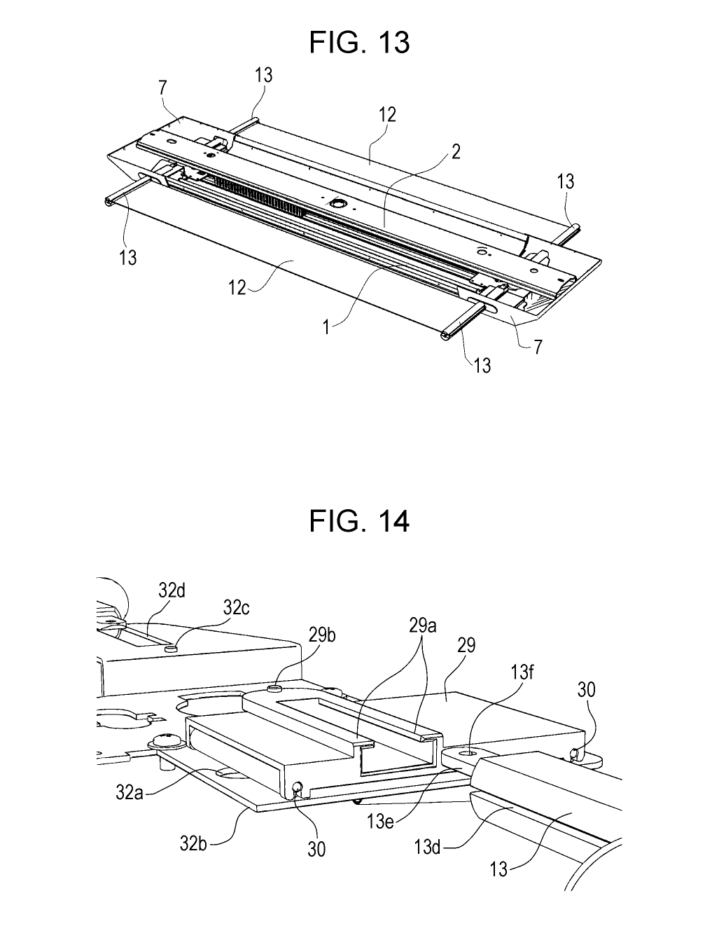

FIG. 13 is an overall perspective view of the lighting fixture viewed from above.

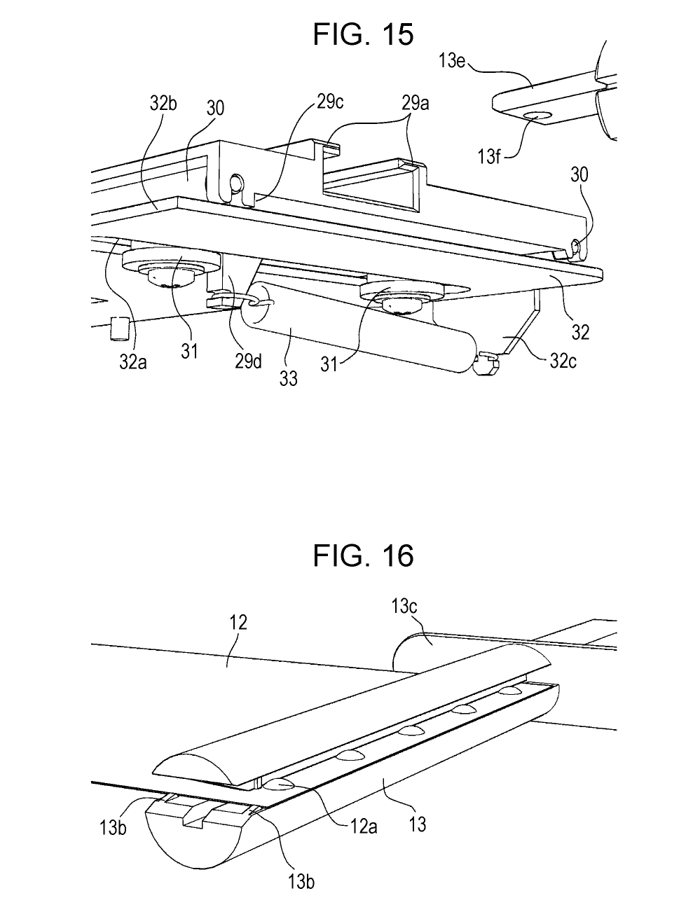

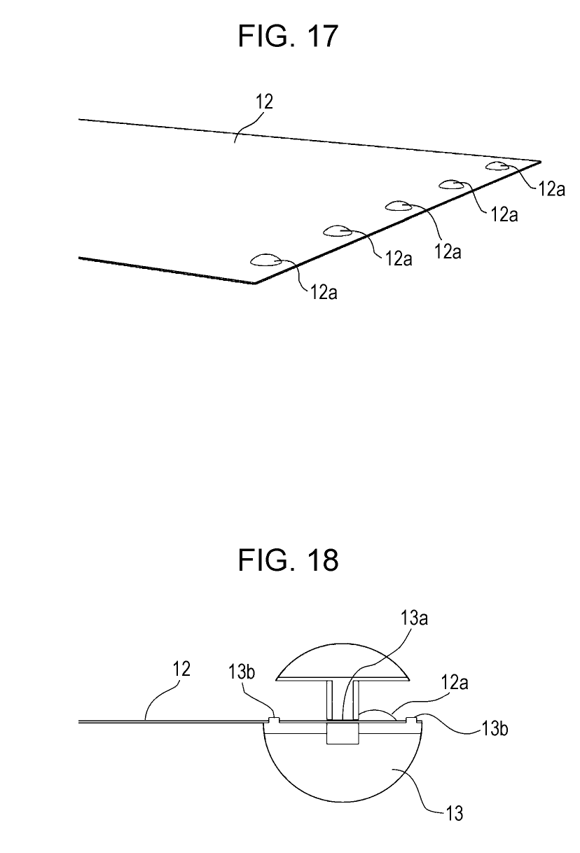

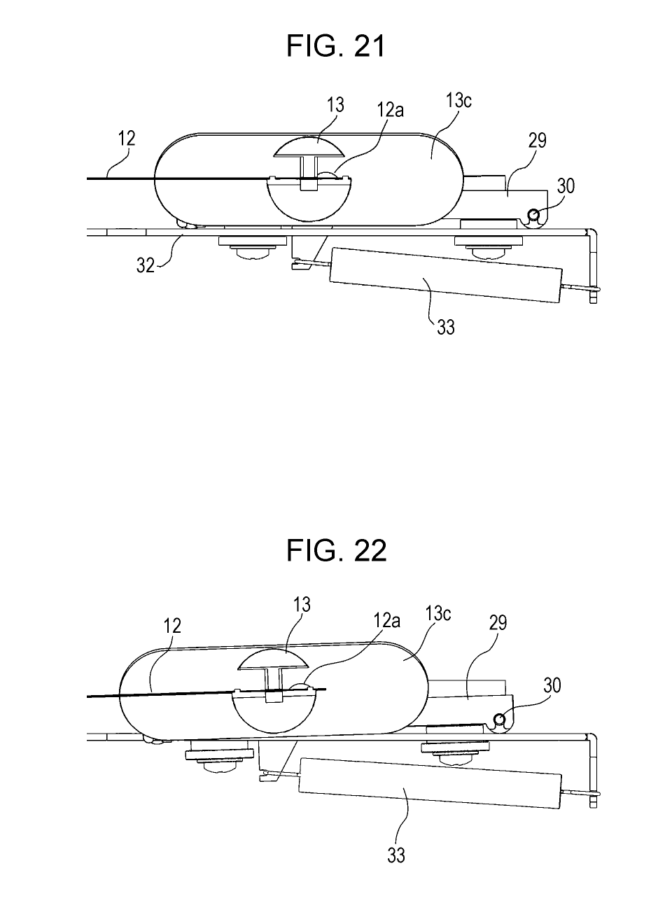

FIGS. 14 to 22 are partial perspective views of a mechanism of the lighting fixture and side views illustrating the operation of the mechanism.

Components having the same functions as those in the first to fourth embodiments are denoted by the same reference numerals.

Reference numeral 1 denotes frames, 2 denotes a chassis, 6 denotes lamp covers, 7 denotes end caps, and 12 denotes advertising films.

LED substrates, LED chips, and a power supply are not illustrated. Reference numeral 12 denotes the advertising films, each having a predetermined number of hemispherical stoppers 12a arranged on both end portions at predetermined intervals. The stoppers 12a may be formed by extrusion molding of a film, by attaching separate components, or by applying a resin. Reference numeral 13 denotes support shafts, each having a slit 13a capable of receiving the corresponding advertising film 12 and having a predetermined length. The slit 13a has an opening slit width that is greater than the thickness of the advertising film 12 and smaller than the height of the stoppers 12a. Each support shaft 13 has stoppers 13b for preventing the advertising film 12 from being removed at the ends thereof. Each support shaft 13 also includes a collar 13c that covers an opening in the corresponding end cap and engagement grooves 13d that engage with a shaft holder 29 described below. A thin plate-shaped engagement plate 13e is formed integrally with each support shaft 13 at an end thereof, and an engagement hole 13f engages with an engagement pin of the shaft holder 29 described below so that the support shaft 13 is positioned and fixed. Reference numeral 29 denotes the shaft holder including collar portions 29a that are fitted to the engagement grooves 13d in the support shaft 13, and a projection 29b that is fitted to the engagement hole 13f formed in the engagement plate 13e of the axial shaft 13. Thus, each support shaft 13 is configured so as to be detachably attachable.

An engagement portion 29c is formed at an end of the shaft holder 29. The engagement portion 29c engages with an end portion of an attachment plate 32 described below to regulate the movement of the shaft holder 29. A spring hook 29d with which a tension spring described below engages is provided on the bottom surface of the shaft holder 29. Rolling shafts 30 are rotatably attached to the bottom surface of the shaft holder 29 at both sides thereof. The rolling shafts 30 roll on the attachment plate 32 described below to reduce the movement load. Side guide rollers 31 arranged in line are also rotatably attached to the bottom surface of the shaft holder 29. The side guide rollers 31 are fitted to a groove 32a in the attachment plate 32 to regulate the rotational direction. Reference numeral 32 denotes the attachment plate that is attached to the corresponding end cap 7 at a predetermined position and has the groove 32a to which the side guide rollers 31 are fitted. Reference numeral 32b denotes an end portion of the attachment plate 32. Reference numeral 32c denotes a spring hook portion, and 32d denotes collar portions that are formed at the opposite side so as to be engageable with the engagement grooves 13d of the corresponding support shaft 13. A projection 32e is also provided so that the corresponding support shaft 13 can be detachably attached. Reference numeral 33 denotes a tension spring that extends between the spring hook 29d of the shaft holder 29 and the spring hook 32c of the attachment plate 32. The spring hook portion 29d and the spring hook portion 32c have different heights so that the tension spring 33 extends at an angle.

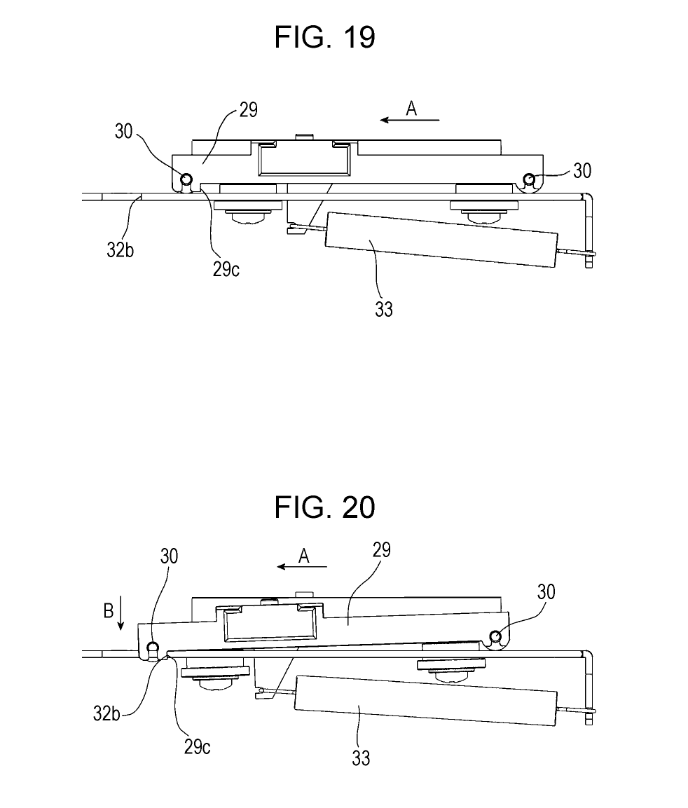

The operation will be described with reference to FIGS. 19 to 22.

FIG. 19 illustrates the state in which the advertising film 12 is displayed while a predetermined tension is applied thereto by the tension spring 33, so that a temperature variation and dimensional differences between components can be absorbed. The rolling shafts 30 enable the shaft holder 29 to smoothly move along the attachment plate 32. When the advertising film 12 is to be replaced, the support shaft 13 is pushed in such a direction that the tension applied to the advertising film 12 is eliminated, that is, in the direction of arrow A. Accordingly, the shaft holder 29 is moved so that one of the rolling shafts 30 falls from the end portion 32b of the attachment plate 32 and stops after moving in the direction of arrow B. This occurs because the tension spring 33 is arranged at an angle and receives forces in the horizontal and vertical directions. The engagement portion 29c of the shaft holder 29 engages with the end portion 32b of the attachment plate 32, and the shaft holder 29 stops while the tension of the tension spring 33 is applied thereto.

At this time, as illustrated in FIG. 22, the stoppers 12a of the advertising film 12 are spaced from the support shaft 13 or in contact with the support shaft 13 without any tension applied thereto. Therefore, the advertising film 12 can be easily pulled out of the slit 13a in the support shaft 13. The advertising film 12 needs to be pulled so as to be bent such that the advertising film 12 moves over the stoppers 13b on the support shaft 13. However, since the advertising film 12 is formed of a thin and highly flexible material, the advertising film 12 can be sufficiently deformed so as to move over the stoppers 13b with a small force when the tension is not applied thereto.

### Sixth Embodiment

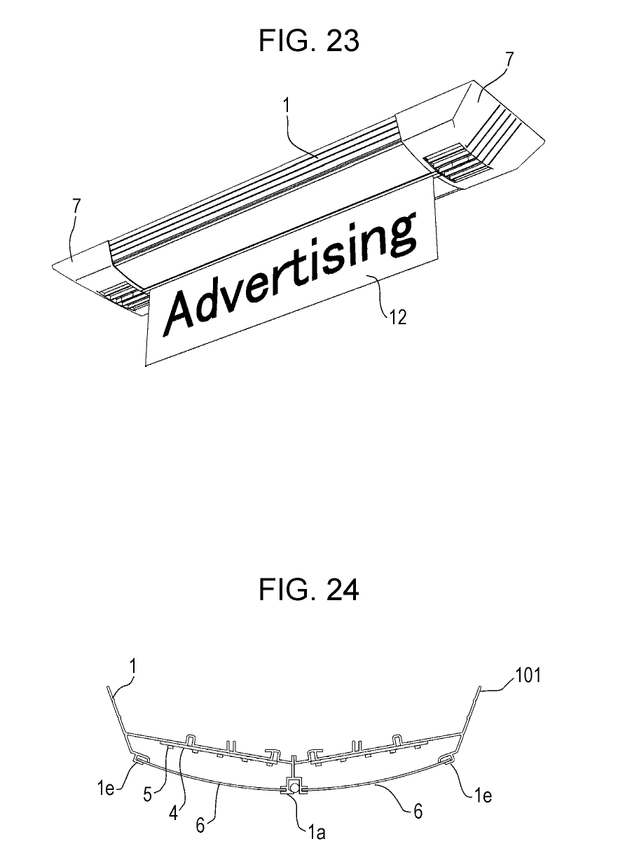

FIG. 23 is an overall perspective view of a lighting fixture according to a sixth embodiment of the present invention viewed from below.

FIG. 24 is a longitudinal sectional view of the lighting fixture.

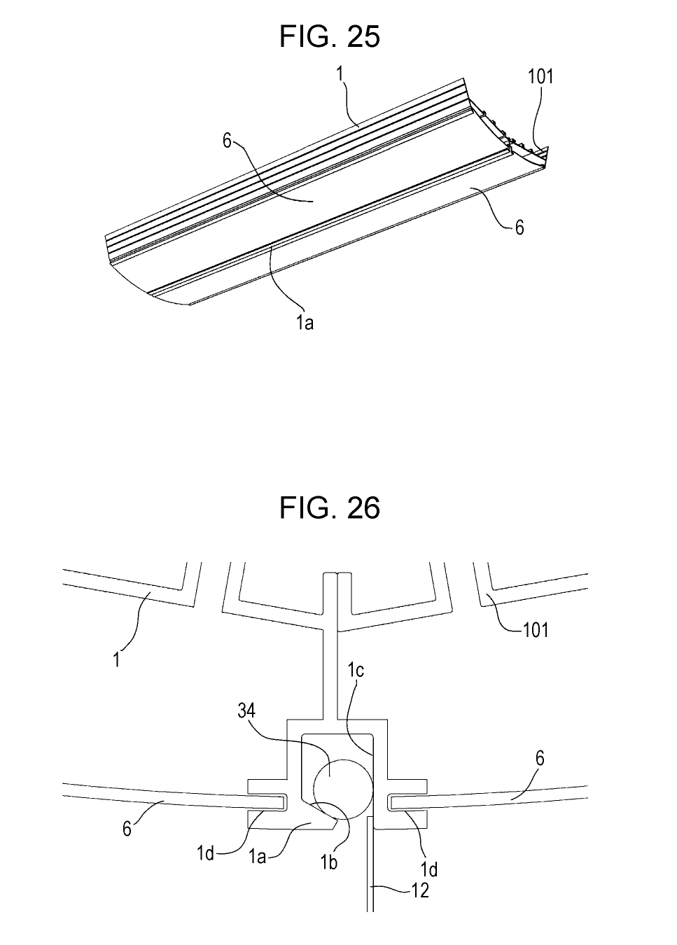

FIG. 25 is a perspective view illustrating the relationship between frame portions and lamp covers viewed from below.

FIGS. 26 to 28 are enlarged longitudinal sectional views illustrating the operation.

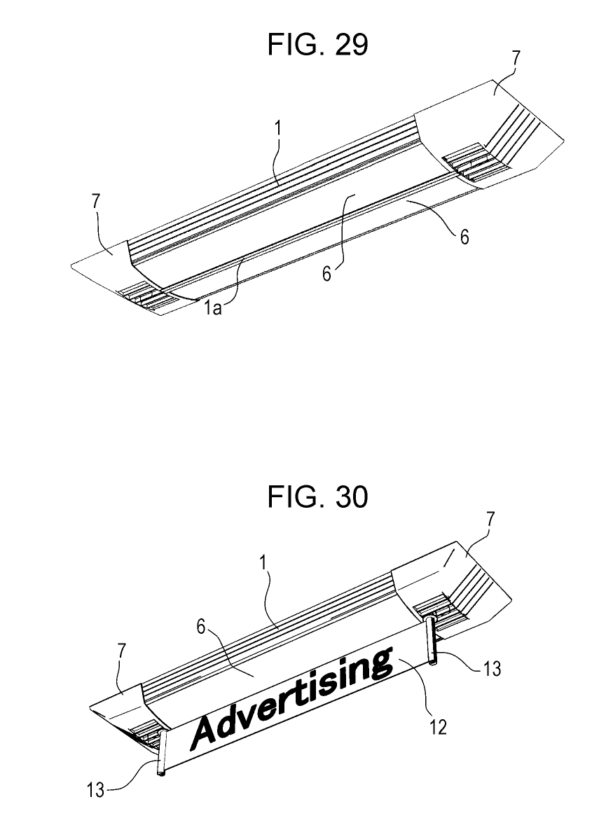

FIG. 29 is an overall perspective view illustrating the state in which no advertising film is presented viewed from below.

Components having the same functions as those in the first to fifth embodiments are denoted by the same reference numerals.

Reference numeral 1 denotes a frame, 4 denotes LED substrates, 5 denotes LED chips, 6 denotes lamp covers, 7 denotes end caps, and 12 denotes an advertising film.

The frame 1 include two components, which are a frame 1 having a paper lock function described below and a frame 101 that does not have the paper lock function. The frame 1 includes a paper lock portion 1a that extends downward in a central section thereof. Reference numeral 1b denotes an inclined surface that is spaced from a receiving surface 1c by a predetermined distance and that is at a predetermined angle. Groove portions 1d that receive the lamp covers 6 are provided at the left and right sides. Groove portions 1e that also receive the lamp covers 6 are provided at both ends of the frame 1. The lamp covers 6 are attached between the groove portions 1d and 1e of the frames so as to have a predetermined curvature. The frames 1 and 101 are strongly fixed and integrated together by a fastening member (not shown). Reference numeral 34 denotes several cylindrical lock pins having a predetermined length. The lock pins are made of plastic or a light metal, and may instead be pipe-shaped as long as the lock pins are sufficiently heavy so as to be disposed at the bottom end due to their own weight.

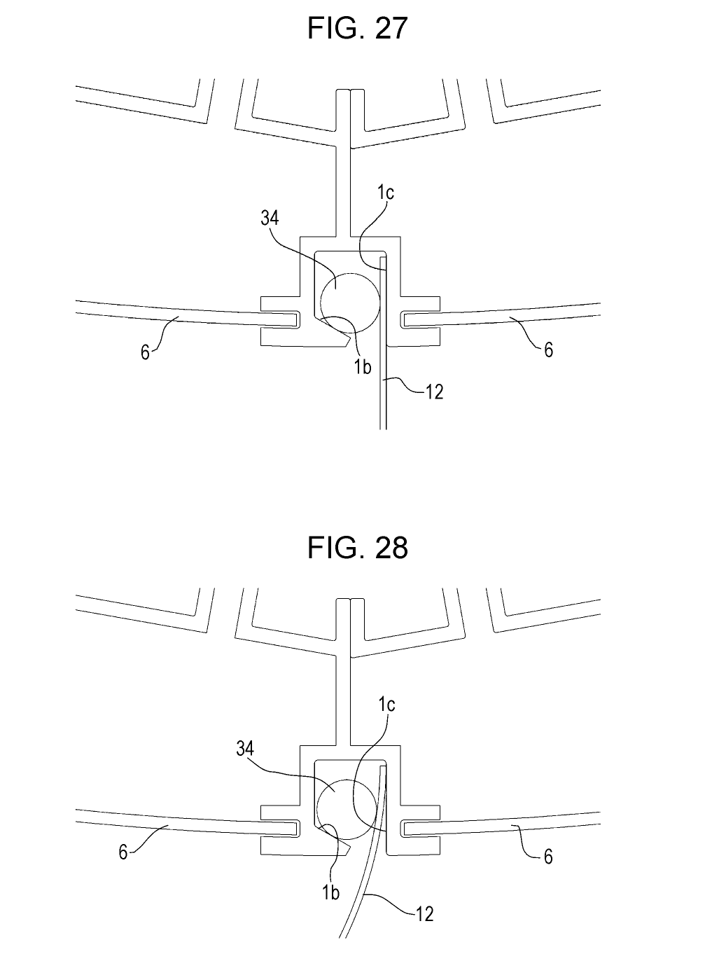

Next, the operation will be described. As illustrated in FIG. 26, the advertising film 12 is inserted into a space between each lock pin 34 and the receiving surface 1c of the frame 1 from below. When the advertising film 12 is inserted, the lock pin 34 is moved along the inclined surface 1b of the frame 1 by a distance corresponding to the thickness of the advertising film 12, and stops at the position illustrated in FIG. 27. The inclined surface 1b and the receiving surface 1c exert a wedge effect, so that the advertising film 12 is retained at that position and does not fall. When the advertising film 12 is to be removed, first, an end portion of the advertising film 12 is pulled toward the lock-pin side, as illustrated in FIG. 28. Accordingly, the advertising film 12 is deformed so as to move the lock pin 34 upward along the inclined surface 1b, so that the wedge effect is cancelled. The advertising film 12 can be pulled out while the wedge effect is canceled by pulling the advertising film 12 obliquely downward, and can therefore be easily replaced.

FIG. 29 is an overall perspective view illustrating the state after the advertising film 12 has been removed.

### Seventh Embodiment

FIG. 30 is an overall perspective view illustrating a seventh embodiment viewed from below.

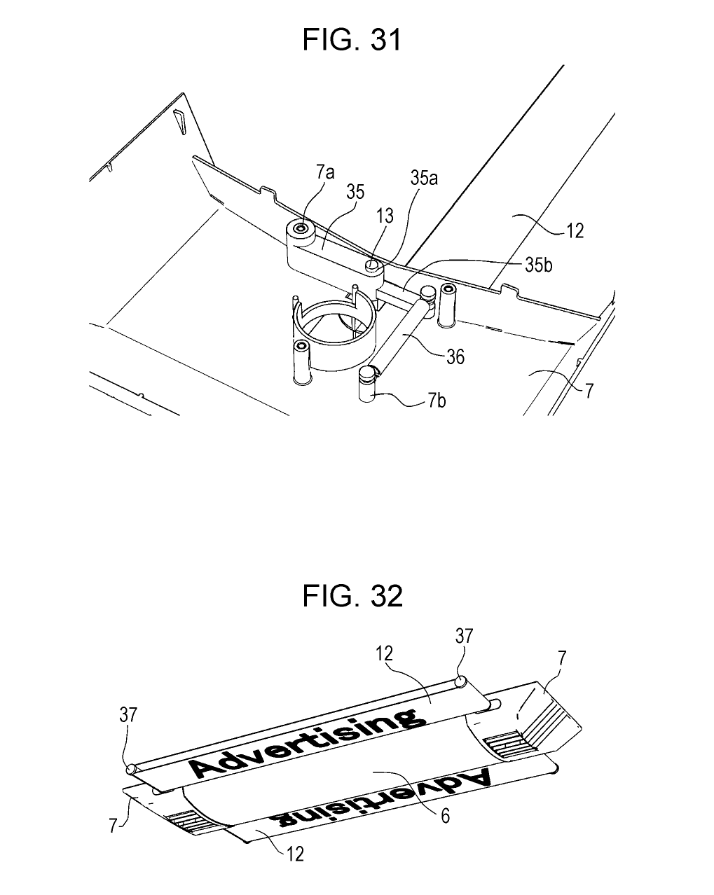

FIG. 31 is a partial enlarged perspective view illustrating a tension applying mechanism of the seventh embodiment.

Components having the same functions as those in the first to sixth embodiments are denoted by the same reference numerals.

Reference numeral 1 denotes frames, 7 denotes end caps, 12 denotes an advertising film, and 13 denotes support shafts. The advertising film 12 is engaged with the support shafts by a method described in the fifth embodiment. A mechanism for applying a predetermined tension to the advertising film 12 will be described with reference to FIG. 31. One of the end caps 7 includes a rotating shaft 7a provided on the inner surface thereof and a spring hook shaft 7b arranged at a predetermined position.

One of the support shafts 13 that hold the advertising film 12 is attached to an engagement portion 35a of a rotating lever 35. The rotating lever 35 is rotatably attached to the rotating shaft 7a, and has a spring hook shaft 35b at the other end thereof. Reference numeral 36 denotes a tension spring that extends between the spring hook shafts 7b and 35b and applies a predetermined rotating force to the rotating lever 35 so that the advertising film 12 that is held receives a predetermined tension. The other support shaft 13 may be fixed. The end cap 7 has an opening corresponding to the movable range of the support shaft 13.

### Eighth Embodiment

Components having the same functions as those in the first to seventh embodiments are denoted by the same reference numerals.

FIG. 32 is an overall perspective view illustrating an eighth embodiment viewed from below.

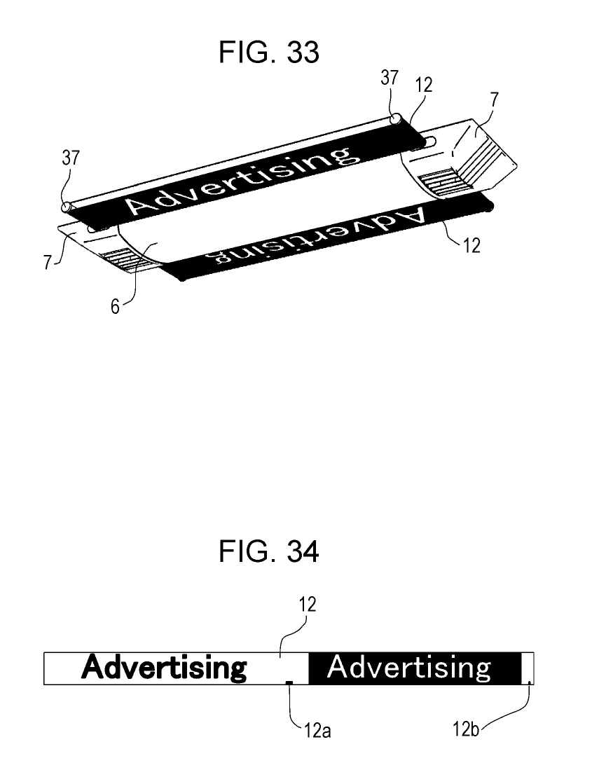

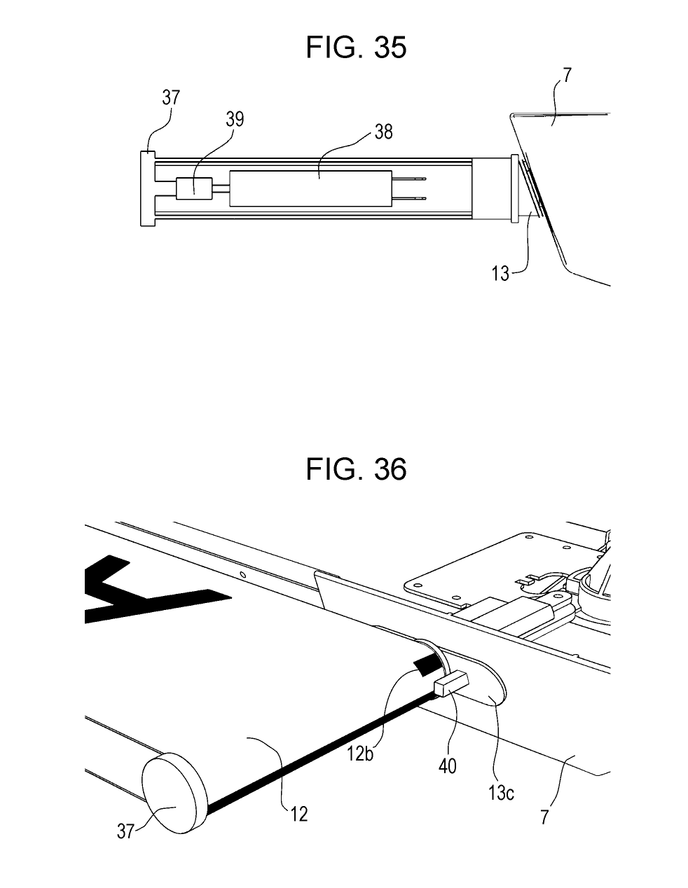

Referring to FIGS. 32 to 35, 6 denotes lamp covers, 7 denotes end caps, 12 denotes advertising films, and 13 denotes support shafts. Each advertising film 12 is bonded to itself so as to form an endless shape and has two advertising surfaces. Identification marks 12a and 12b are printed on each advertising film 12 at predetermined positions. Reference numeral 37 denotes rotating shafts that are arranged at both ends such that the advertising films 12 are looped therearound. The outer peripheral surfaces of the rotating shafts 37 are coated with urethane or the like or have a component made of rubber or the like bonded thereto so as to be capable of exerting a predetermined frictional force and transmitting a driving force to the advertising films 12. The rotating shafts 37 are rotatably attached to the above-described support shafts 13. One of each pair of rotating shafts 37 is connected to a motor 38 disposed in the corresponding support shaft 13 with a universal coupling 39, and rotates in synchronization with the rotation of the motor 38. A driving circuit and wires for the motor are not illustrated. Refer to the fifth embodiment for the mechanism for applying a tension to the advertising film 12. Only one of each pair of rotating shafts 37 needs to be provided with a driving unit. Reference numeral 40 denotes a reflective photointerrupter used to detect the identification marks 12a and 12b on the advertising film 12.

The operation will now be described. Each advertising film 12 is rotated by rotating the motor 38, and is stopped at a predetermined position by detecting the identification mark 12a or 12b with the photointerrupter 40. The advertising surface of the advertising film 12 to be currently displayed is located at the bottom. When the advertising surface to be displayed changes depending on the time of the day or season, the motor 38 is rotated so that the other surface of the advertising film is displaced. The desired surface can be displayed by automatically reversing the advertising film by using a timer provided on the motor driving circuit, or by manually rotating the advertising film.

### Ninth Embodiment

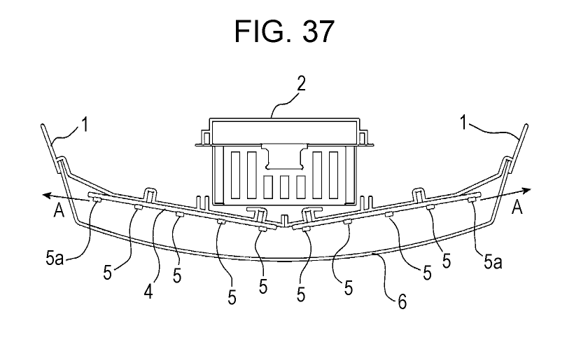

FIG. 37 is a longitudinal sectional view illustrating a ninth embodiment.

Components having the same functions as those in the first to eighth embodiments are denoted by the same reference numerals.

Reference numeral 1 denotes frames, 2 denotes a chassis, 4 denotes LED substrates, 5 denotes LED chips, and 6 denotes a lamp cover. The LED chips 5 include LED chips 5a arranged along lines near the end portions of the lighting fixture. The LED chips 5a are so-called side-emission chips that emit light from the side surfaces thereof. The main light beams emitted from the re-emission LED chips 5a travel in the directions of arrow A. Therefore, in the case where advertising films 12 are displaced on the sides of the lighting fixture, the advertising surfaces can be brightly illuminated so that the visibility thereof is increased. When an additional substrate is provided to illuminate the side surfaces, wires and fixing components for the substrate are required, and the selling price increases accordingly. However, when surface-mounting LED chips are used, the LED chips can be simultaneously mounted with a mounter. Accordingly, the productivity is increased and an increase in the selling price can be reduced.

Although preferred embodiments of the present invention have been described with reference to the drawings, the present invention is not limited to the above-described embodiments. It is to be understood that other embodiments and various modifications conceivable by a person skilled in the art within the scope of the invention described in the claims are included in the technical scope of the present invention.

### INDUSTRIAL APPLICABILITY

The lighting fixture according to the present invention is not limited to those having the structures of conventional lighting fixtures, and provides increased serviceability and new market opportunity as a new advertising medium by ensuring a sufficient space for displaying an advertisement material and actively illuminating the advertising object with a light beam from a light source to increase visibility. Furthermore, a lighting fixture that has been used only to light a room can also be used as an advertising medium, and the additional function of the lighting fixture increases the marketability of the lighting fixture. Moreover, by utilizing the light beams from the LED chips for lighting the room as the light source for illuminating the advertising object, the advertising object can be illuminated without increasing the power consumption.

The lighting fixture can be used not only to reduce power consumption but also as a new advertising medium in the field of advertisement.

An advertising income can be received by displaying an advertising object in, for example, shops, stations, platforms, bus stops, or other public spaces. Accordingly, when energy-saving light sources such as LED light sources are used, not only can the electricity costs be reduced, but a new source of income can be obtained.

Introduction of lighting fixtures that effectively reduce CO₂ emission requires purchase costs for the new lighting fixtures and replacement costs. The advertising income provides an incentive for the introduction, and widespread use of LED lights greatly contributes to reducing CO₂ emission, which is the main cause of global warming.

### REFERENCE SIGNS LIST

1 frame

2 chassis

4 LED substrate

5 LED chip

6 lamp cover

7 end cap

12 advertising film

13 support shaft

14 lock lever

15 rotating collar

17 urging spring

21 stretching sheet

23 advertisement receiver

26 retainer band

29 shaft holder

32 attachment plate

33 tension spring

34 lock pin

37 rotating shaft

38 motor

40 photointerrupter

1-9. (canceled)

10. A lighting fixture comprising:
an LED light source for lighting;
a frame that has a central axis in a longitudinal direction and holds the LED light source such that the LED light source is oriented downward;
a pair of lamp covers that are disposed below the frame and protect the LED light source; and
a paper lock portion arranged along the central axis of the frame,
wherein one end of each of the pair of lamp covers is held by the frame, and
wherein the other end of each of the pair of lamp covers is held by the paper lock portion.

11. The lighting fixture according to claim 10, wherein the paper lock portion includes a receiving surface that extends downward, an opposing surface that opposes the receiving surface with a space therebetween, and an inclined surface that extends obliquely downward at a predetermined angle from a bottom end of the opposing surface, a bottom end of the receiving surface and a distal end of the inclined surface forming an opening therebetween,
wherein the paper lock portion includes a lock pin having a diameter that is greater than a distance between the bottom end of the receiving surface and the distal end of the inclined surface and smaller than a distance between the receiving surface and the opposing surface, and
wherein the lock pin is inserted in a space between the receiving surface, the opposing surface, and the inclined surface.

12. The lighting fixture according to claim 11, wherein the paper lock portion extends downward from a location near the central axis of the frame.
